(19) United States
(12) Patent Application Publication
(10) Pub. No.: US 2026/0029130 A1
(43) Pub. Date: Jan. 29, 2026

(54) ELECTRIC FIREPLACE WITH HOLOGRAPHIC FAN

(71) Applicant: Westlake Studios, Limited, Kowloon Bay (HK)

(72) Inventor: Matthew Alfred Crowe, Dongguan City (CN)

(73) Assignee: Westlake Studios, Limited, Kowloon Bay (HK)

(21) Appl. No.: 19/279,081

(22) Filed: Jul. 24, 2025

Related U.S. Application Data
(60) Provisional application No. 63/675,308, filed on Jul. 25, 2024.

(51) Int. Cl. F24C 7/00; G03H 1/00

(52) U.S. Cl. CPC F24C 7/004; G03H 1/0005

(57) ABSTRACT

The present disclosure relates to an electric fireplace with a holographic fan, comprising a front ornament assembly and a holographic fan assembly, wherein the holographic fan assembly is embedded at the rear of the front ornament assembly, the holographic projection device is programmed to display a holographic image.

### TECHNICAL FIELD

The present disclosure generally relates to an electric fireplace and more particularly to an electric fireplace with a holographic fan.

### BACKGROUND

Most electric fireplaces generally include an electric heater, a flame generator, a front projection screen or back projection panel, and simulated ornaments such as fire logs, coals, stones or fire glass tray. The flame generator typically adopts a rotary spindle, including a light source and a reflector. The reflector is used to reflect the light emitted by the light source, and the light changes are achieved by driving the reflector to rotate through a motor. The undulating light effect caused by the reflections is then projected on the front side of the flame generator through a translucent screen or the back side of the flame generator onto an opaque panel. Simulated ornaments, are usually placed in front of the flame generator to form a combined simulation effect with the undulating light projection.

The heater cavity and air chamber is separate from the simulation effect and typically consists of a motor driven blower wheel which forces air through electrical heating elements.

Therefore, the present structures of electric fireplaces are complex with a large number of components, which increases costs for assembly and manufacturing, also space occupied inside the enclosure of the fireplace. The simulated flame and effect also have limiting factors as it can only create a single type of flame shape, which is based on the reflector's shape and must be reflected onto an opaque panel, object, or through a translucent screen for the light effect to be visible to the user.

### SUMMARY

An objective of the present disclosure is to design an electric fireplace with a holographic fan, which can achieve a dual function of holographic imaging and channeling of forced air and forced convection heat in the upper or lower extremities of the vent located over or beneath the simulated effect. The electric fireplace with a holographic fan of the present disclosure has the technical advantages of creating diverse simulation effects without a projection screen or panel, reduced number of parts, lower assembly and manufacturing costs, increased amount of air blown out, and can dissipate heat of other electrical equipment, such as AV equipment, placed within the mantle or cabinet of the fireplace.

The present disclosure relates to an electric fireplace with a holographic fan, comprising a translucent front ornament assembly and a holographic fan assembly, wherein the holographic fan assembly is embedded at the rear of the front ornament assembly, the holographic projection device is designed to display holographic images which allows for several different types of flame simulation shapes. The positioning of the fan blades allows the shapes to be visible above the front ornament assembly and through the translucent portion of the front ornament assembly. Preferably, the holographic fan assembly comprises at least two fan blades and a shaft, a holographic projection device is arranged on the fan blades, the fan blades can rotate around the shaft.

In some embodiments, the holographic fan assembly is directly mounted on the back wall of the electric fireplace, or the holographic fan assembly is mounted on the back wall of the electric fireplace by a bracket. Preferably, at the rear of the holographic fan assembly is provided with a rear background member which is finished or molded to look like an ornament, the holographic fan assembly is mounted onto the rear background member or the front ornament assembly, or embedded between the rear background member and the front ornament assembly.

In some embodiments, the holographic fan assembly is designed so that when turned off, the fan blades return to be positioned behind the front ornament assembly ornament thus visually hidden to the user. Preferably, the rear background member has a housing, a magnet is placed between the fan blade and the housing of the rear background member, so that the fan blade could return and stay in a horizontal position hidden behind the front ornament assembly when the fan motor is turned off.

In another embodiment, a reflector is mounted on the fan blades, a light source which is in front of fan blade is mounted under or behind the front ornament assembly, the light emitted from the light source is reflected by the reflectors on the fan to create a flame simulation image visible above the front ornament and through the translucent portion of the front ornament.

In another embodiment, further comprising a heating assembly, wherein a vent opening leading to an air chamber is arranged above and/or below the front ornament assembly for communicating the space where the heating element is located and the space where the front ornament assembly is located. Preferably, at least the tips of the fan blades extend adjacent to the vent opening when turning.

In some embodiments, further comprising a base, wherein the base is disposed at the lower part of the fireplace. Preferably, the base has a cavity with an opening, through which the fan blade can rotate in the cavity of the base. This allows to use a longer blade for a larger image while reducing the height and size of the front ornament by allowing the blades to rotate through the base at the mid-lower rotational path.

Preferably, a vent is placed above or below the front ornament assembly, or two vents are separately placed above and below the front log assembly. In another embodiment, an AV equipment is placed in a storage above the vent, the vent is communicated with the storage to ventilate and dissipate heat from the AV equipment.

### BRIEF DESCRIPTION OF THE DRAWINGS

These and other features, aspects, and advantages of the present invention will become better understood with reference to the following description, appended claims, and accompanying drawings, in which similar reference characters refer to similar parts, and in which:

FIG. 1 shows a sectional view of a first embodiment of the electric fireplace according to the disclosure.

FIG. 2 shows a sectional view of a second embodiment of the electric fireplace according to the disclosure.

FIG. 3a shows a sectional view of a third embodiment of the electric fireplace according to the disclosure, with a blower wheel.

FIG. 3b shows a sectional view of a fourth embodiment of the electric fireplace according to the disclosure, without a blower wheel.

FIG. 4 shows a top view of a holographic fan assembly according to the electric fireplace shown in FIG. 3a and FIG. 3b.

FIG. 5 shows a schematic view of a fan blade according to the disclosure.

FIG. 6 shows a schematic view of another fan blade according to the disclosure.

FIG. 7 shows schematic views of the fan blade hidden or not by the front frog assembly.

FIG. 8 shows an example of a holographic fan assembly according to the disclosure.

FIG. 9 shows an example of the holographic fan assembly shown in FIG. 8, which is mounted to a rear log assembly.

FIG. 10a shows a front view of the front ornament assembly with a hollow cavity.

FIG. 10b shows an inside view of the hollow front ornament assembly as shown in FIG. 10a.

FIG. 10c shows an example of the holographic fan assembly mounted between a rear cavity and a front cavity.

FIG. 10d shows a projection effect of the holographic fan assembly according to the present disclosure.

FIG. 11 shows another example of the holographic fan assembly according to the present disclosure.

FIG. 12 shows a sectional view of a fifth embodiment of the electric fireplace according to the disclosure, with a projection screen.

FIG. 13 shows a sectional view of a sixth embodiment of the electric fireplace according to the disclosure, with a separated vent.

### DETAILED DESCRIPTION

In order to make the objectives, technical solutions and advantages of the present disclosure clearer, the embodiments of the present disclosure will be described below in detail with reference to the accompanying drawings. The technical features in different embodiments of the present disclosure may be combined with each other if not conflicted.

Embodiments of the present invention are described herein in the context of a modular assembled electric fireplace. More particularly, it enables greater flexibility to the consumer for the overall design of the electric fireplace, as well as offering various cost and product development efficiencies. For example, numerous options for different components of the electric fireplace can be incorporated together in any desired manner to provide various alternatives for the consumer in terms of the overall size, shape, design and aesthetic appearance of the electric fireplace.

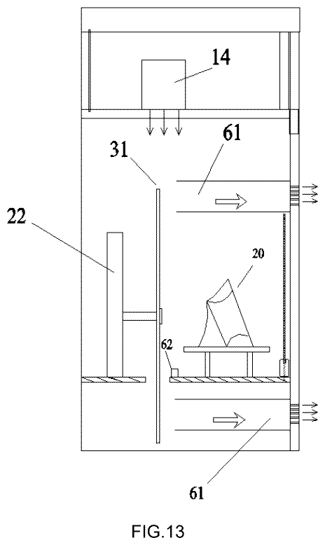

The electric fireplace according to the present disclosure is to use a holographic fan to make a flame effect and display the flame effect through panel. The electric fireplace comprises a heating assembly 40, a log assembly 20, a holographic fan assembly 30 and a front panel 10. The front panel 10 could be made of glass and could be transparent or translucent. The log assembly 20 could be comprised with a grate and a loose log arranged above the grate. In certain embodiments, as shown in FIG. 13, wind from the holographic fan assembly can be channeled into a vent 61 placed above or below the log assembly and this vent 61 may hold the heating assembly or be without a heating assembly. Fireplace enclosure or base is hollow to allow the log assembly to be elevated and create space for the blade to go through, which will be described in details as below.

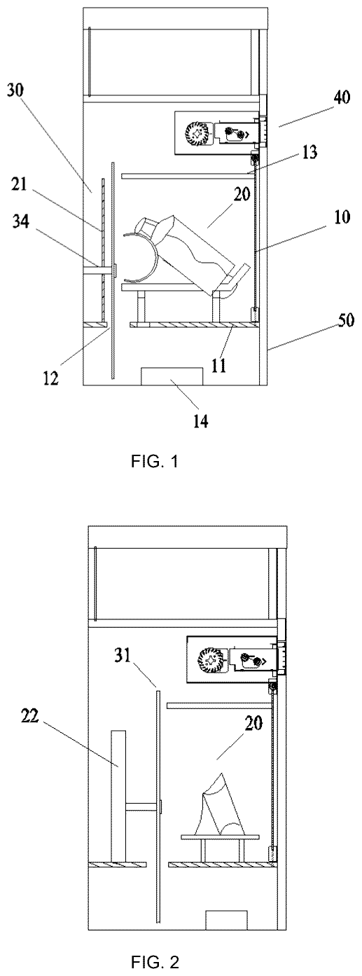

As shown in FIG. 1, The holographic fan assembly 30 is embedded at the rear of the front ornament assembly 20. The holographic fan assembly 30 comprises at least two fan blades, on which a holographic projection device is arranged. The holographic fan assembly 30 is capable of rotating, and the holographic projection device can be programmed to display a holographic image. For example an animated effect such as different fire flame effects or a Christmas themed animation or a scenery effect can be simulated. The hologram image is displayed in the mid-upper portion of the rotational path where the fan blades rotate above the front assembly and also through the translucent portion of the front ornament assembly 20 which can be viewed through the front panel 10. The front ornament assembly 20 is preferably translucent, and the front panel 10 is preferably transparent. Preferably, at the rear of the holographic fan assembly 30 is provided with a rear background member 21. The rear background member 21 can be finished such as painted, or molded to look like an ornament. The holographic fan assembly 30 can be directly mounted on the back wall of the electric fireplace, also can be mounted by a bracket 34 provided on the back wall of the electric fireplace.

The fireplace will typically be installed inside a mantel structure or AV cabinet. The mantel structure or cabinet may have storage for other electrical components such as a computer or a game station or a control circuit board, et. al. These electrical components would generate heat when works, and the temperature in the enclosed space of the mantel or cabinet is high, which is not conducive to heat dissipation. Vents 61 can be made in these storage areas which lead to the fan assembly to allow for ventilation.

The rear background member 21 and the front ornament assembly 20 are supported by a lower clapboard 11 arranged above a base. Preferably, the lower clapboard 11 is provided with an opening 12, so that the fan blade 31 can rotate in the cavity of the base by going through the opening 12. The advantage of this setup is that a larger fan blade can be used to project a larger simulation image in the upper portion of the rotational path over the front ornamental assembly while maintaining a visually pleasing height ratio of the front ornamental assembly, since the lower portion of the rotational path can be hidden within the base.

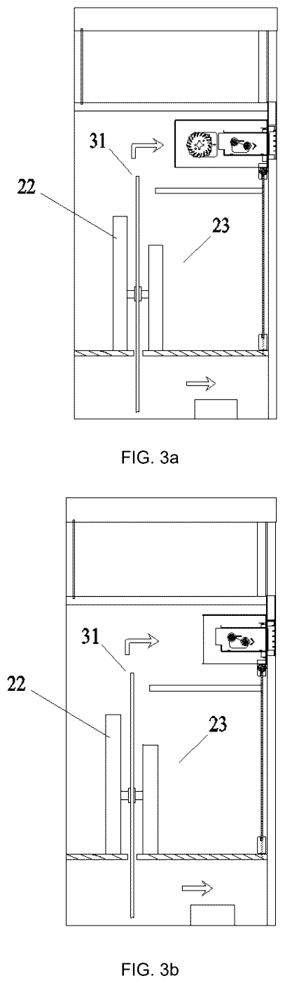

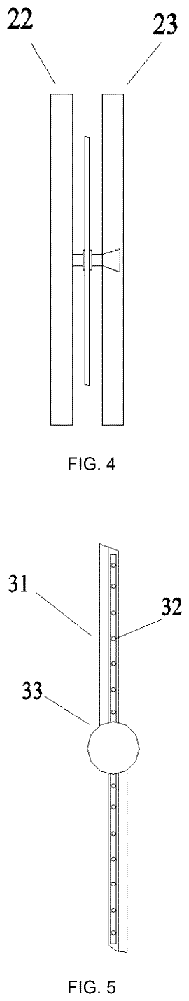

A vent opening leading to an air chamber is arranged above and/or below the front ornament assembly for communicating the space where the front ornament assembly is located. The vent opening could be arranged on an upper clapboard 13 or the lower clapboard 11. Preferably, at least the tips of the fan blades extend adjacent to the vent opening when turning. Such vents can be used simultaneously or individually above and/or below the front ornament assembly. Under such circumstance, the blower wheel could be ignored as shown in FIG. 3b.

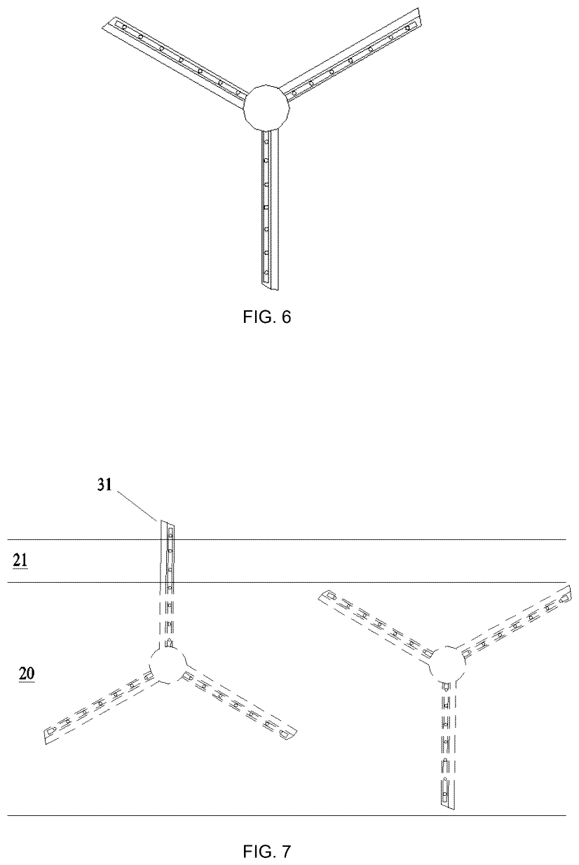

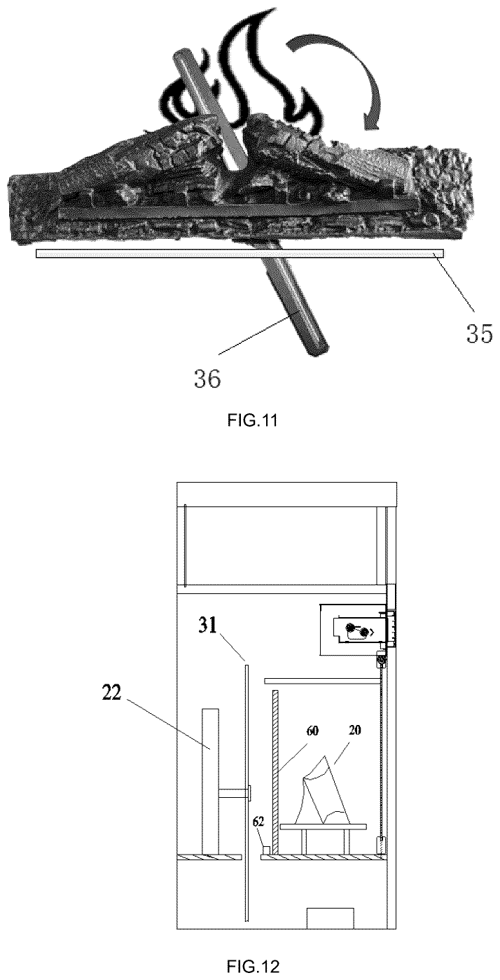

As shown in FIG. 5-6, the holographic fan assembly 30 may include at least two blades 31, which are symmetrically arranged around a shaft 33 hidden by the front ornament assembly 20. The blade 31 can be a straight type or a curved type and can provided with a holographic projection device 32. When the blade 31 rotates, the holographic projection device 32 carries out holographic projection on the front ornament assembly 20, so that user can observe the projection effect through the front panel 10. In another embodiment, as shown in FIG. 11, a light source 35 can be separated from the fan, and reflectors 36 are mounted onto the fan blades. The light source 35 which is in front of fan blade is mounted behind the front ornament assembly and in front of the fan assembly. The light emitted from the light source 35 can be reflected by the reflectors 36 in the mid-upper portion of the rotational path where the fan blades rotate above the front ornament assembly 20 and also through the translucent portion of the front ornament assembly 20.

As shown in FIG. 7, the holographic fan assembly 30 is arranged so that when turned off, the blades are hidden between the enclosure formed by the rear background member 21 and the front ornament assembly 20, and not visible from the front side. The front ornament assembly 20 is translucent, so that it can only show the image that the hologram projection device 32 emits. The image is projected in and above the front ornament assembly while hiding the shaft 33 of the fan. When the hologram projection device 32 does not work, the blades are positioned in a hidden position, in which the blades are hidden by the front ornament assembly 20 and are not visible from the front side.

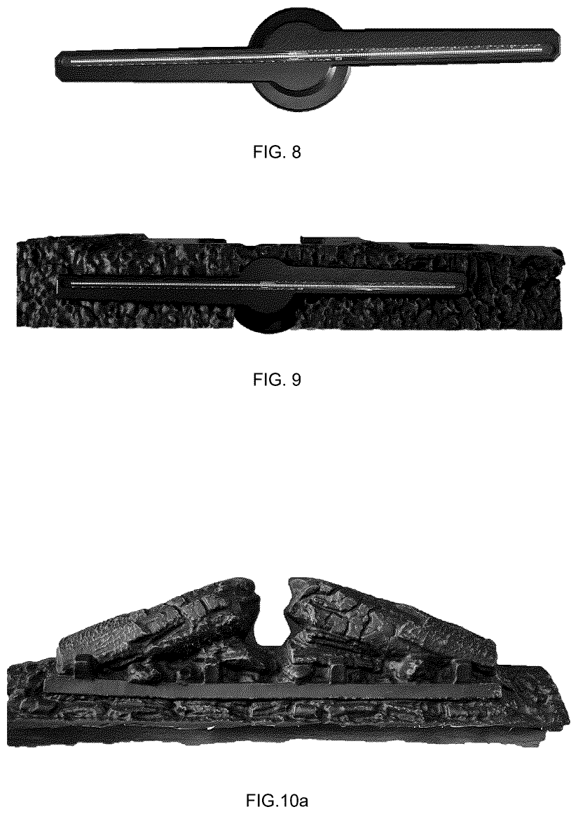

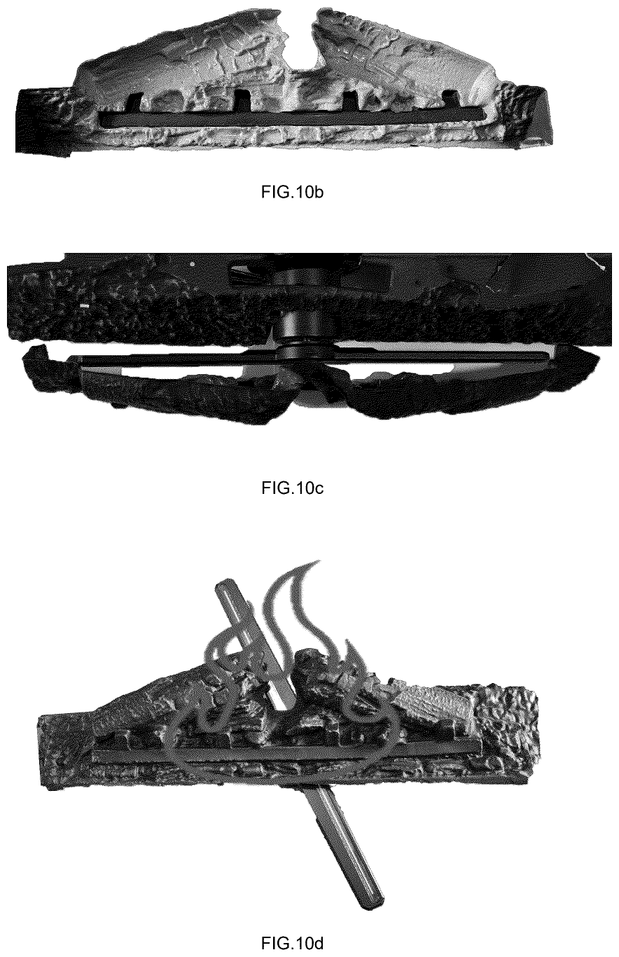

FIG. 8 shows an example of a holographic fan assembly with two blades. FIG. 9 shows an example of the holographic fan assembly shown in FIG. 8, which is mounted to a housing of the rear background member. A magnet can be placed between the blade and the rear housing, so that the blade could return and stay in a horizontal flat position hidden behind the front housing. FIG. 10a and FIG. 10b show an example of a front ornament assembly, behind which the holographic fan assembly shown in FIG. 8 is arranged. FIG. 10a shows a front view of the translucent front ornament assembly, which could have a hollow cavity. FIG. 10b shows an inside view of the hollow front ornament assembly. As shown in FIG. 10d, blades can create the image light visible in the area over the front ornament assembly, which could be a front cavity logset or ornament, and also through the translucent portion of the logset or ornament. Blade is not visible when the unit is turned off, as it stays on the horizontal flat position and the front cavity can keep it hidden.

In another embodiment, the holographic fan assembly 30 can be embedded between a front ornament assembly 20 and a rear log assembly 22. Wherein, the holographic fan assembly 30 can be mounted to either of the front ornament assembly 20 or the rear log assembly 22 directly or by a bracket 34, as shown in FIG. 2. Preferably, the bracket could also be molded onto the front ornament assembly 20 or the rear log assembly 22. Also, the holographic fan assembly 30 can be mounted to either of the front ornament assembly 20 or the rear log assembly 22, as shown in FIG. 3a and FIG. 3b. FIG. 10c shows an example of the scheme shown in FIG. 3a and FIG. 3b, in which the holographic fan assembly is mounted between a rear cavity and a front cavity. Between the rear cavity and the front cavity, there is an open space to allow fan blades to go though.

As shown in FIG. 12, a projection screen 60 is disposed between the front ornament assembly 20 and the holographic fan assembly 30, so as to play a combined effect with the front ornament assembly and even with the rear background member. The electric fireplace according to the present disclosure can also provided with no heating assembly. A vent 61 can be placed above or below the log assembly.

As shown in FIG. 13, there are two vents 61 separately placed above and below the log assembly as shown therein. Also, the AV equipments 14 can be placed in the storage above the vent. The vent 61 under the storage or through the back could be used to ventilate and dissipate heat from the AV equipments 14. In both embodiments shown in FIG. 12 and FIG. 13, a light strip 62 can be arranged between the front ornament assembly 20 and the holographic fan assembly 30, or between the projection screen 60 and the holographic fan assembly 30.

By using the holographic fan assembly described above, a dual function of holographic imaging and force convection could be achieved. It also allows to freely adjust the displayed effect of the fireplace as required while keeping the fan blades hidden when not in use. The electric fireplace with a holographic fan in present disclosure has a simple structure, with lowered costs for manufacturing and installation. Also, the blades of the fan can be used to help ventilate the heat generated by other electrical devices stored in the mantel or cabinet.

It is also possible to combine loose logs and other ornaments such as stones crystals, to allow the consumer to place the log assemblies in their preferred configuration, since the grate is not electrified. Further, in various embodiments, the components of the electric fireplace can be configured relative to one another so that they can be packaged together much more compactly, which can provide even further cost efficiencies.

Although the implementations of the present disclosure are described above, the contents descried are only implementations used to understand the present disclosure and not intended to limit the present disclosure. Without departing from the spirit and scope disclosed by the present disclosure, any person skilled in the art to which the application belongs can make any modifications and alterations to the forms and details of implementation. However, the protection scope of the present disclosure shall still be subject to the scope defined by the appended claims.

I claim:

1. An electric fireplace with a holographic fan, comprising a front ornament assembly and a holographic fan assembly, wherein the holographic fan assembly is embedded at the rear of the front ornament assembly, the holographic projection device is designed to display a holographic image.

2. The electric fireplace with a holographic fan according to claim 1, wherein the holographic fan assembly comprises at least two fan blades and a shaft, a holographic projection device is arranged on the fan blades, the fan blades can rotate around the shaft.

3. The electric fireplace with a holographic fan according to claim 1, wherein the holographic fan assembly is directly mounted on the back wall of the electric fireplace, or the holographic fan assembly is mounted on the back wall of the electric fireplace by a bracket.

4. The electric fireplace with a holographic fan according to claim 2, wherein, at the rear of the holographic fan assembly is provided with a rear background member, the rear background member is finished or molded as to appear as an ornament such as a log.

5. The electric fireplace with a holographic fan according to claim 4, wherein the holographic fan assembly is mounted onto the rear background member or the front ornament assembly, or embedded between the rear background member and the front ornament assembly.

6. The electric fireplace with a holographic fan according to claim 4, wherein the holographic fan assembly is designed so that when turned off, the fan blades are hidden by the front ornament assembly.

7. The electric fireplace with a holographic fan according to claim 6, wherein the rear background member has a housing, a magnet is placed between the fan blade and the housing of the rear background member, so that the fan blade could return and stay in a horizontal position hidden behind the front ornament assembly when not in use.

8. The electric fireplace with a holographic fan according to claim 2, wherein a reflector is mounted on the fan blades, a light source which is in front of fan blade is mounted under or behind the front ornament assembly, the light emitted from the light source is reflected by the reflector to the create an image.

9. The electric fireplace with a holographic fan according to claim 1, further comprising a projection screen disposed between the front ornament assembly and holographic fan assembly.

10. The electric fireplace with a holographic fan according to claim 2, further comprising a heating assembly, wherein an upper vent opening is arranged above the front ornament assembly for communicating the space where the heating assembly is located and the space where the front ornament assembly is located.

11. The electric fireplace with a holographic fan according to claim 10, wherein the fan blades extend into the space where the heating element is located to push out heated air.

12. The electric fireplace with a holographic fan according to claim 4, further comprising a base, wherein the base is disposed at the lower part of the fireplace, the rear background member and the front ornament assembly are supported by a lower clapboard arranged above the base.

13. The electric fireplace with a holographic fan according to claim 12, wherein the base has a hollow cavity, the lower clapboard is provided with an opening, through which the fan blade can rotate in the cavity of the base.

14. The electric fireplace with a holographic fan according to claim 13, wherein at least one electrical component is arranged in the cavity of the base.

15. The electric fireplace with a holographic fan according to claim 1, wherein a vent is placed above or below the front ornament assembly, or two vents are separately placed above and below the front log assembly.

16. The electric fireplace with a holographic fan according to claim 15, wherein an AV equipment is placed in a storage above the vent, the vent is communicated with the storage to ventilate and dissipate heat from the AV equipment.
